(19) United States
(12) Patent Application Publication
(10) Pub. No.: US 2017/0122018 A1
(43) Pub. Date: May 4, 2017

(54) HINGE

(71) Applicant: Acer Incorporated, New Taipei City (TW)

(72) Inventors: Yu-Chin Huang, New Taipei City (TW); Chih-Chun Liu, New Taipei City (TW); Yu-Nan Lin, New Taipei City (TW); Hung-Jen Su, New Taipei City (TW)

(73) Assignee: Acer Incorporated, New Taipei City (TW)

(21) Appl. No.: 15/256,044

(22) Filed: Sep. 2, 2016

(30) Foreign Application Priority Data
Oct. 29, 2015 (TW) 104135675

(51) Int. Cl. E05D 11/10; E05D 3/02; G06F 1/16; E05D 5/06

(52) U.S. Cl. CPC E05D 11/1078; E05D 5/06; E05D 3/02; G06F 1/1681; E05Y 2900/606; E05D 2011/1035

(57) ABSTRACT

A hinge including a first bracket, a second bracket, a shaft, a fixing element and a position limiting ring is provided. The first bracket includes a first hole and a protrusion protruding from edge of the first hole toward inside of the first hole. The second bracket includes a second hole. The shaft has a cylinder portion passing through the first hole, a fixing portion passing through the second hole, and a first position limiting structure encircling the shaft. The fixing element is disposed at ends of the cylinder portion to fix the shaft to the first bracket. The position limiting ring encircles the shaft and located between the first bracket and the first position limiting structure. The position limiting ring has a second position limiting structure and a recess, the second position limiting structure engages with the first position limiting structure, and the protrusion is located in the recess.

### CROSS-REFERENCE TO RELATED APPLICATION

This application claims the priority benefit of Taiwan application serial no. 104135675, filed on Oct. 29, 2015. The entirety of the above-mentioned patent application is hereby incorporated by reference herein and made a part of this specification.

### BACKGROUND OF THE INVENTION

1. Field of the Invention

The invention generally relates to a hinge, and more particularly, a hinge having a structure very different from that of a conventional hinge.

2. Description of Related Art

In electronic devices, such as notebook computer and Tablet PC, hinges are required to be installed for enabling a screen of each of the electronic devices to rotate relative to a keyboard or to be opened up or closed. As the electronic devices on the market, such as the notebook computer and so forth, are developed towards being light, thin and small-scale, a size of traditional hinges is difficult to be designed smaller.

In detail, for a current electronic device on the market such as a notebook computer, the hinges being used are mainly divided into spring-type (as shown in FIG. 1A) and question-mark-bend-type (as shown FIG. 1B). A traditional spring-type hinge produces torque with elasticity and friction of a spring, and the number of the spring can be adjusted in response to the needs of the torque. However, with respect to the current electronic device such as the notebook computer, the number of the spring is unable to be effectively decreased, and thus a size of the hinges is unable to be reduced; and as more springs are being used, an assembly time being required will also be increased.

On the other hand, a question-mark-bend-type hinge uses an iron sheet to rub against a central shaft to produce torque, the torque of this type of hinge can be adjusted according to a friction area, and thus the size of the hinge is also unable to be effectively reduced. Moreover, the iron sheet being used to produce friction is manufactured by pressing or folding process, and thus may cause instability in the torque due to unpredictable factor during the processing, thereby effecting a product yield.

### SUMMARY OF THE INVENTION

The invention is directed to a hinge which has a structure very different from that of a conventional hinge.

A hinge of the invention includes a first bracket, a second bracket, a shaft, a fixing element, and a position limiting ring. The first bracket has a first hole and a protrusion, wherein the protrusion protrudes from the edge of the first hole towards the inside of the first hole. The second bracket has a second hole. The shaft has a cylinder portion, a fixing portion and a first position limiting structure connected to each other. The cylinder portion passes through the first hole and protrudes out of the first bracket, the fixing portion passes through the second hole and protrudes out of the second bracket, and the first position limiting structure encircles the cylinder portion. The fixing element is disposed at an end of the cylinder portion to fix the shaft on the first bracket. The position limiting ring encircles between the first hole and the shaft, and is located between the first bracket and the first position limiting structure, wherein the position limiting ring has a second position limiting structure and an engaging recess. The second position limiting structure is distributed along the circumference of the position limiting ring and protrudes along an axial direction of the shaft. The engaging recess is located on a circumferential surface of the position limiting ring. The second position limiting structure engages the first position limiting structure. The protrusion is located in the engaging recess.

In an embodiment of the invention, a cross-sectional shape of the fixing portion is non-circular, and a shape of the second hole matches a shape of the fixing portion.

In an embodiment of the invention, the first position limiting structure and the second position limiting structure respectively have a plurality of teeth, and the teeth of the first position limiting structure are engaged with the teeth of the second position limiting structure. The engaging recess appears to be a curved recess having an arc-shaped on the circumferential surface along the axial direction. When the first bracket rotates relative to the second bracket, the protrusion moves from a center to an endpoint of the curved recess to drive the first position limiting structure to move away from the second position limiting structure.

In an embodiment of the invention, the hinge further includes an elastic pad disposed between the fixing element and the first bracket. The number of the elastic pad can be two, and the elastic pads can be tapered metal springs and taper tips of the elastic pads protrude outward along the axial direction.

In an embodiment of the invention, the hinge further includes a shield element encircling the shaft and located between the first bracket and the second bracket, the shield element is configured to cover the first position limiting structure and the second position limiting structure that are engaged with each other.

In view of the above, the invention provides a hinge structure having a structure very different from that of the conventional hinge. The hinge of the invention, as compared to the conventional hinge, has the benefits of being reduced in size and enhanced in stability during actuation.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of a conventional spring-type hinge.

FIG. 1B is a schematic diagram of a conventional question-mark-bend-type hinge.

FIG. 2 is a schematic assembly diagram of a hinge according to an embodiment of the invention.

FIG. 3A is an exploded diagram of FIG. 2.

FIG. 3B is a schematic diagram of FIG. 3A from another view angle.

FIG. 4 is a schematic diagram of a position limiting ring in FIG. 2.

FIG. 5 is a schematic assembly diagram of the position limiting ring and a first bracket.

FIG. 6A is a schematic diagram of a protrusion located in the engaging recess.

FIG. 6B through FIG. 6D are flow diagrams illustrating the actuation of the hinge.

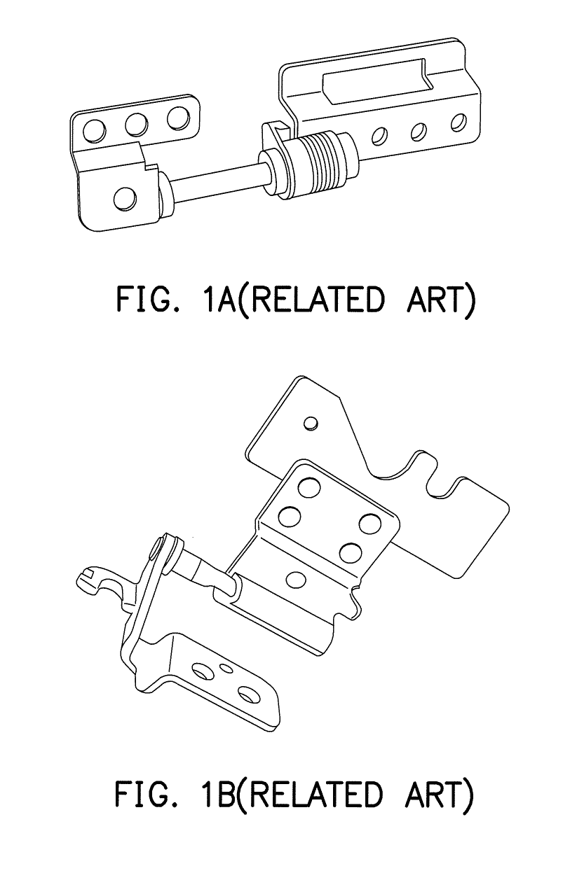

### DESCRIPTION OF THE EMBODIMENTS

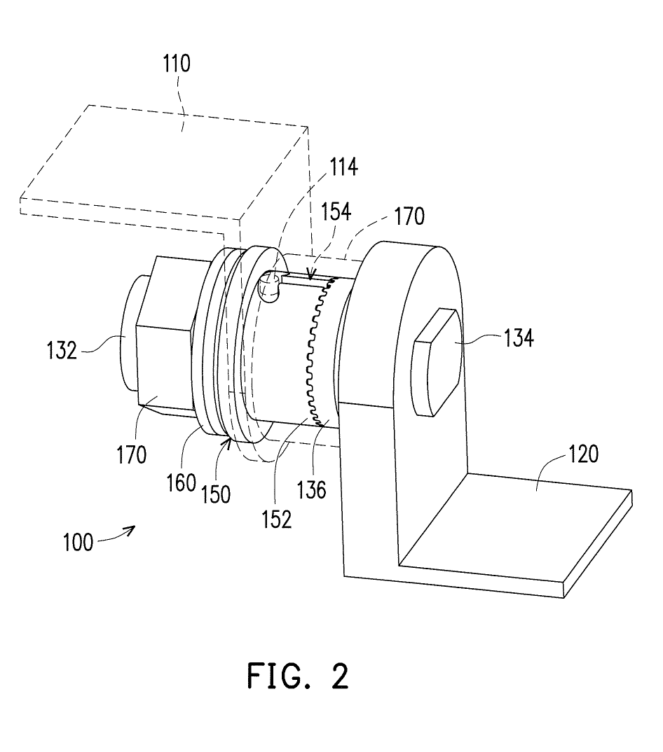

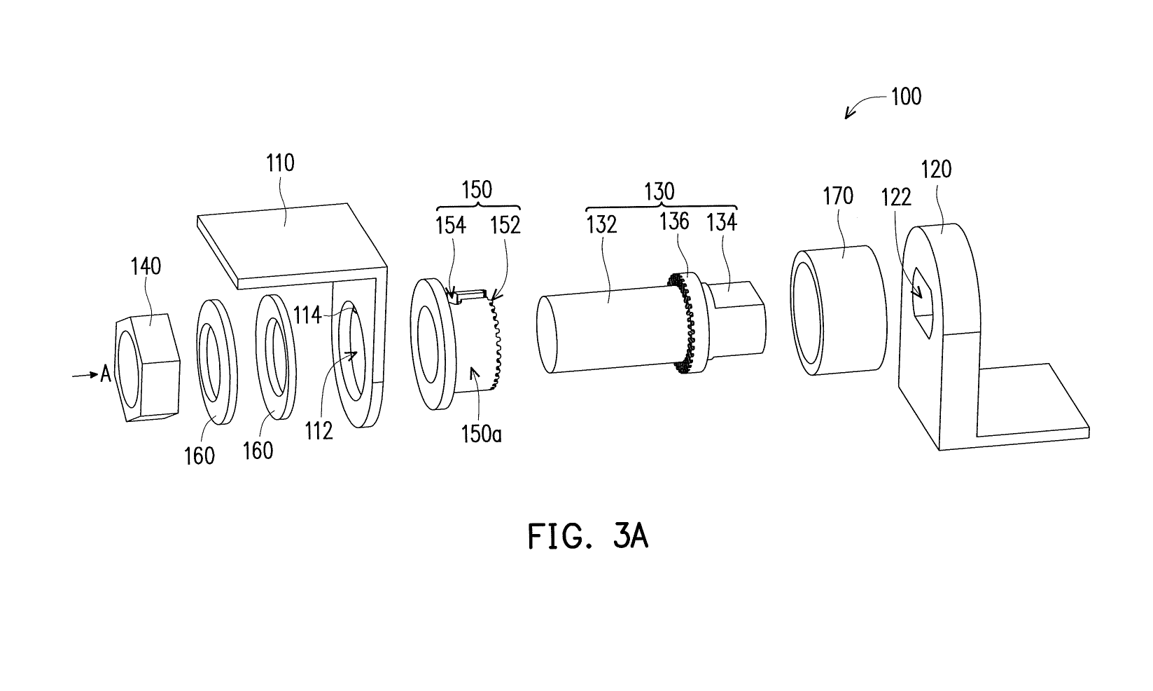

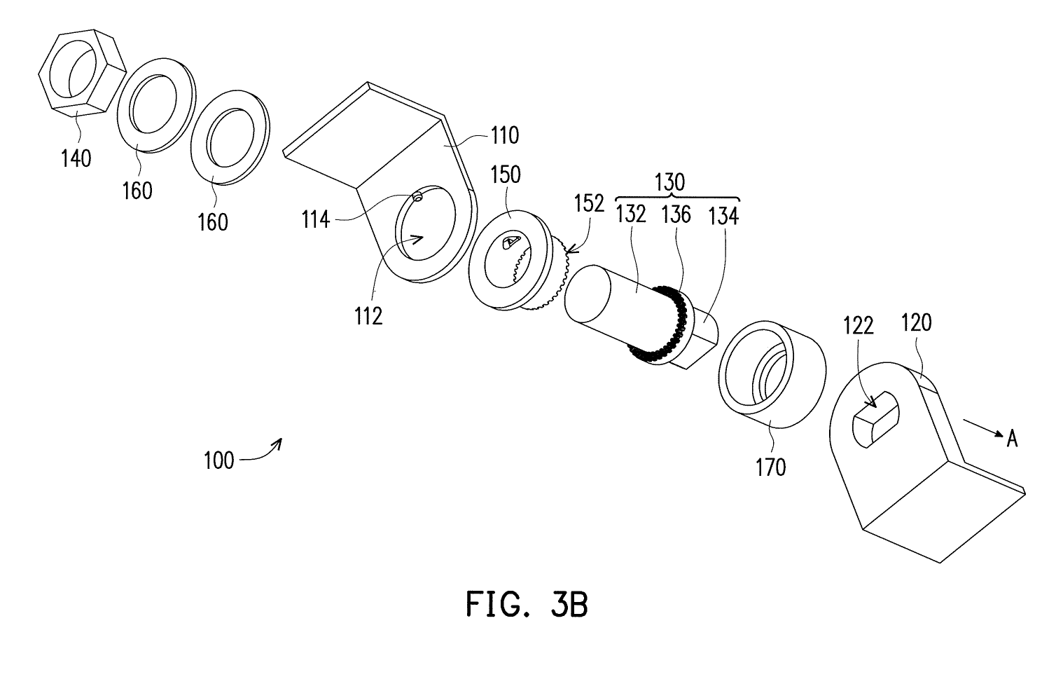

FIG. 2 is a schematic assembly diagram of a hinge according to an embodiment of the invention. FIG. 3A is an exploded diagram of FIG. 2. FIG. 3B is a schematic diagram of FIG. 3A from another view angle.

Referring to FIG. 2, FIG. 3A and FIG. 3B at the same time, a hinge 100, which is applicable in an electronic device such as a notebook computer or a foldable tablet PC, includes a first bracket 110, a second bracket 120, a shaft 130, a fixing element 140, and a position limiting ring 150. The first bracket 110 is, for example, disposed in an upper casing installed with a screen. The first bracket 110 has a first hole 112 and a protrusion 114, and the protrusion 114 protrudes from the edge of the first hole 112 towards the inside of the first hole 112. The second bracket 120 having the second hole 122 is, for example, disposed in a lower casing installed with a keyboard. The shaft 130 has a cylinder portion 132, a fixing portion 134 and a first position limiting structure 136 connected to each other, wherein the cylinder portion 132 passes through the first hole 112 and protrudes out of the first bracket 110, the fixing portion 134 passes through the second hole 122 and protrudes out of the second bracket 120, and the first position limiting structure 136 encircles the cylinder portion 132. The fixing element 140 is disposed at an end of the cylinder portion 132 to fix the shaft 130 on the first bracket 110. The position limiting ring 150 encircles between the first hole 112 and the shaft 130, and is located between the first bracket 110 and the first position limiting structure 136. The position limiting ring 150 has a second position limiting structure 152 distributed along the circumference of the position limiting ring 150 and protruding along an axial direction of the shaft 130 and an engaging recess 154 located on a circumferential surface of the position limiting ring 150, wherein the second position limiting structure 152 and the first position limiting structure 136 are engaged with each other, and the protrusion 114 is located in the engaging recess 154.

In detail, the first hole 112 may be circular in shape, and an inner diameter of the first hole 112 is slightly greater than or equal to a diameter of the cylinder portion 132, so that the first bracket 110 may rotate relative to the shaft 130; and in the axial direction of the shaft 130, a cross-sectional shape of the fixing portion 134 is non-circular, and a shape of the second hole 122 matches the shape of the fixing portion 134, so that the fixing portion 134 can be fitted into the second hole 122 favorably, thereby limiting the shaft 130 from rotating relative to the second bracket 120.

The first position limiting structure 136 and the second position limiting structure 152 respectively have a plurality of teeth (not shown), and in normal condition, the teeth of the first position limiting structure 136 are engaged with the teeth of the second position limiting structure 152. Noteworthily, the teeth can be composed by inclined surfaces and fillets, and thus when the first position limiting structure 136 and the second position limiting structure 152 are interfering with each other, the teeth can be prevented from breaking caused by excessive interference force between teeth to teeth and can smoothly guide each other into motion.

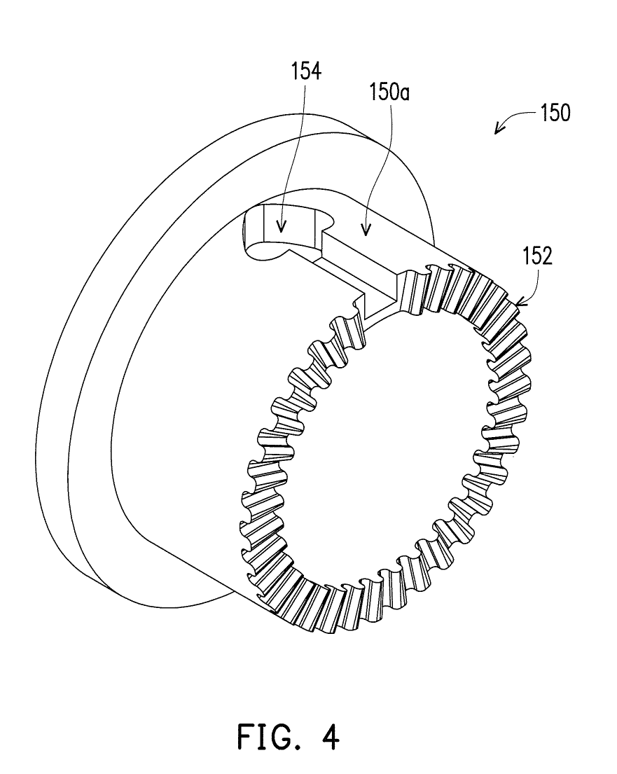

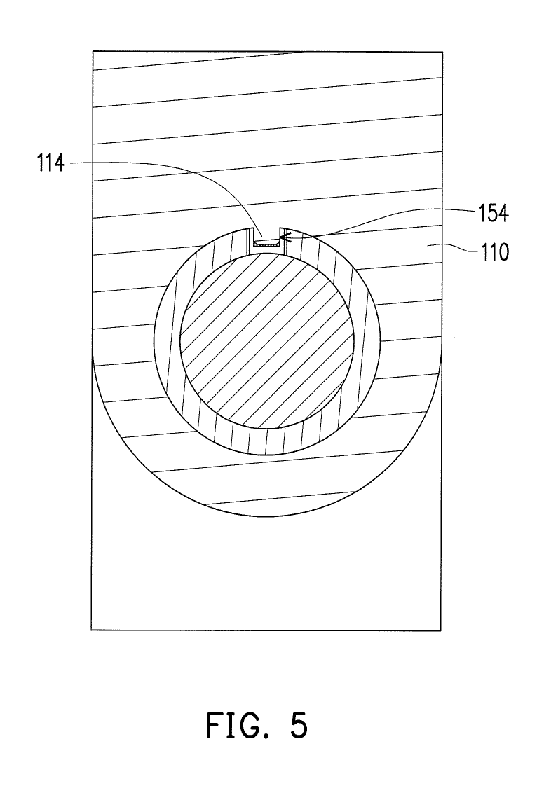

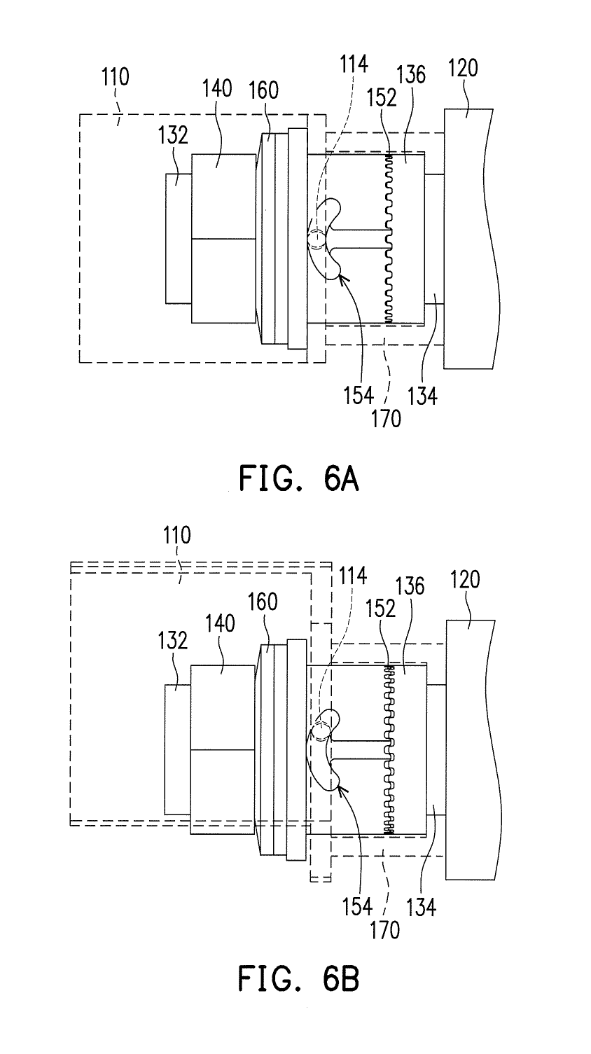

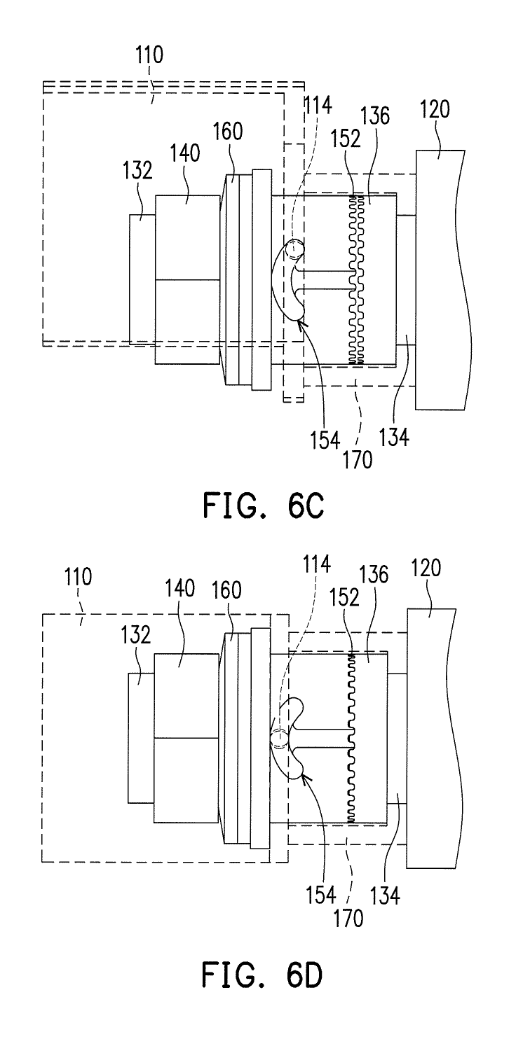

FIG. 4 is a schematic diagram of the position limiting ring in FIG. 2. FIG. 5 is a schematic assembly diagram of the position limiting ring and the first bracket. FIG. 6A is a schematic diagram of the protrusion located in the engaging recess. Referring to FIG. 4, FIG. 5 and FIG. 6A at the same time, the engaging recess 154 appears to be a curved recess having an arc-shaped on a circumferential surface 150a of the position limiting ring 150 along the axial direction A. In detail, along the axial direction A, two endpoints of the curved recess are relatively close to the second position limiting structure 152, and the center of the curved recess is relatively away from the second position limiting structure 152. In normal condition (i.e., under the condition that the first position limiting structure 136 and the second position limiting structure 152 are engaged with each other), the protrusion 114 of the first bracket 110 is located at the center of the curved recess.

Referring to FIG. 2 and FIG. 6A at the same time, in simple terms, when rotating the first bracket 110, the protrusion 114 will move from the center of the curved recess towards the endpoint, so that the second position limiting structure 152 of the position limiting ring 150 will move away from the first position limiting structure 136, and thus the first bracket 110 will not be limited by the second position limiting structure 152 and can be rotated to an angle required by a user. Then, the protrusion 114 can be returned to the center of the curved recess with possible means. Detail descriptions regarding the actuation means will be provided hereinafter.

Referring to FIG. 2, FIG. 3A and FIG. 3B, the hinge 100 may further includes an elastic pad 160 disposed between the fixing element 140 and the first bracket 110, so as to drive the protrusion 114 to automatically return from the endpoint of the curved recess back to the center via a resilience of the elastic pad 160, thereby enabling the teeth of the second position limiting structure 152 of the position limiting ring 150 to be re-engaged with the teeth of the first position limiting structure 136. The elastic pad 160 of the present embodiment may be a tapered metal spring, wherein the number of the elastic pad 160 may be two, and taper tips of the two elastic pads 160 both protrude outward along the axial direction A.

As shown in FIG. 6A, in general condition, the protrusion 114 of the first bracket 110 is located in the center of the curved recess; at this moment, by having the taper tips of the two elastic pads 160 pointing outwards (the taper tip of one elastic pad 160 pointing towards the fixing element 140, while the taper tip of the other elastic pad 160 pointing towards the first bracket 110), the elastic pads 160 simultaneously apply force on the fixing element 140 and the first bracket 110 to enable the teeth of the first position limiting structure 136 to engage with the teeth of the second position limiting structure 152, so that the protrusion 114 of the first bracket 110 can be kept at the center of the curved recess.

FIG. 6B through FIG. 6D are flow diagrams illustrating the actuation of the hinge 100. Next, as shown in FIG. 6B, when rotating the upper casing (not shown) that is installed with the first bracket 110, the elastic pads 160 are deformed due to an interference force between the protrusion 114 of the first bracket 110 and the curved recess of the position limiting ring 150 being greater than the resilience of the elastic pads 160, and thus the position limiting ring 150 moves from the center of the curved recess towards the endpoints along with the protrusion 114 in the curved recess, so as to move to the left of FIG. 6B, as shown in FIG. 6C, and thus the teeth of the first position limiting structure 136 are moved out of the teeth of the second position limiting structure 152.

Since an action time of the user in rotating the upper casing relative to the lower casing is not long, when the protrusion 114 is kept at the endpoint of the curved recess, as shown in FIG. 6C, an interference between the first position limiting structure 136 and the second position limiting structure 152 is very small; at this moment, the user can freely adjust the upper casing to any angle relative to the lower casing according to the needs.

Next, as show in FIG. 6D, when the user finishes adjusting the angle of the upper casing in relative to the lower casing, the elastic pads 160 with the resilience thereof are restored in shape while applying force to the position limiting ring 150; at this moment, because the protrusion 114 and the curved recess are interfering with each other, the protrusion 114 returns from the endpoint of the curved recess to the center of the curved recess to drive the position limiting ring 150 into rotation, so as to enable the teeth of the first position limiting structure 136 to re-engage with the teeth of the second position limiting structure 152.

In addition, the hinge 100 further includes a shield element 170 encircling the shaft 130 and located between the first bracket 110 and the second bracket 120. The shield element 170 is configured to shield the first position limiting structure 136 and the second position limiting structure 152 that are engaged with each other, so as to prevent dust or foreign matter from entering between the teeth and influencing the engagement of the first position limiting structure 136 and the second position limiting structure 152.

In summary, the engagement of the position limiting structures being used in the hinge of the invention, as compared to the conventional hinge that requires the use of spring, can allow the upper and lower casings of the electronic device to rotate or to be opened up or closed without requiring the use of spring. Therefore, the invention basically discloses a hinge with a structural design very different from that of the conventional hinge.

Furthermore, in the hinge of the invention, the shaft and the position limiting ring are encircling each other, and thus, in addition to increasing in the simplicity and beauty of the appearance design of the hinge, an overall size of the hinge is also effectively reduced.

In addition, structures of the selected elements in the hinge are simple and convenient for assembling, and thereby can reduce an assembly time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A hinge, comprising:
a first bracket, having a first hole and a protrusion, the protrusion protruding from the edge of the first hole towards the inside of the first hole;
a second bracket, having a second hole;
a shaft, having a cylinder portion, a fixing portion and a first position limiting structure connected to each other, wherein the cylinder portion passes through the first hole and protrudes out of the first bracket, the fixing portion passes through the second hole and protrudes out of the second bracket, and the first position limiting structure encircles the cylinder portion;
a fixing element, disposed at an end of the cylinder portion to fix the shaft on the first bracket; and
a position limiting ring, encircling between the first hole and the shaft, and located between the first bracket and the first position limiting structure, the position limiting ring having a second position limiting structure distributed along the circumference thereof and protruding along an axial direction of the shaft and an engaging recess located on a circumferential surface of the position limiting ring, wherein the second position limiting structure engages with the first position limiting structure, and the protrusion is located in the engaging recess.

2. The hinge as recited in claim 1, wherein a cross-sectional shape of the fixing portion is non-circular.

3. The hinge as recited in claim 1, wherein the first position limiting structure and the second position limiting structure respectively have a plurality of teeth, and the teeth of the first position limiting structure are engaged with the teeth of the second position limiting structure.

4. The hinge as recited in claim 3, wherein the engaging recess appears to be a curved recess having an arc-shaped on the circumferential surface along the axial direction.

5. The hinge as recited in claim 4, wherein when the first bracket rotates relative to the second bracket, the protrusion moves from a center to an endpoint of the curved recess to drive the first position limiting structure to move away from the second position limiting structure.

6. The hinge as recited in claim 1, further comprising an elastic pad disposed between the fixing element and the first bracket.

7. The hinge as recited in claim 6, wherein the number of the elastic pad is two, and the elastic pads are tapered metal springs and taper tips of the elastic pads protrude outward along the axial direction and.

8. The hinge as recited in claim 1, further comprising a shield element encircling the shaft and located between the first bracket and the second bracket to shield the first position limiting structure and the second position limiting structure that are engaged with each other.
